(19) United States
(12) Patent Application Publication
(10) Pub. No.: US 2026/0226733 A1
(43) Pub. Date: Aug. 6, 2026

(54) A JOINT FOR WALL PANELS MADE OF CROSS LAMINATED TIMBER

(71) Applicant: CLT FACTORY, SIA, Talsi (LV)

(72) Inventors: Eriks Meinarts, Talsi (LV); Peter Frandsen, Talsi (LV)

(73) Assignee: CLT FACTORY, SIA, Talsi (LV)

(21) Appl. No.: 19/153,941

(22) PCT Filed: Jan. 11, 2024
(86) PCT No.: PCT/LV2024/050002

§ 371 Date: Aug. 5, 2025

(30) Foreign Application Priority Data
Feb. 6, 2023 (LV) LVP2023000012

(51) Int. Cl. E04B 1/61

(52) U.S. Cl. CPC E04B 1/6141; E04B 2001/6195; E04B 2103/04

(57) ABSTRACT

The present invention relates to a wall panel joint comprising a first wall panel (1) and a second wall panel (20). The first wall panel (1) in the middle section thereof comprises a T-slot (8). The second wall panel (20) on its first side edge (22) comprises an L-type extension (27). The Upon assembly of the first wall panel (1) with the second wall panel (20), the L-type extension (27) of the second wall panel (20) is received in the T-slot (8) of the first wall panel (1) and a wedge space (39) is formed. The wall panel joint further comprises a set of two wedges (30). Upon assembly of the wall panels (1; 20) both wedges (30) are inserted into the wedge space (39) so that the interference fit is formed therebetween. The wall panels are made of a cross laminated timber.

### FIELD OF THE INVENTION

The present invention relates to wall panel joints, especially to the wall panels made of a cross laminated timber (CLT).

### BACKGROUND OF THE INVENTION

The prior art discloses various wall panel joints. One of such wall panel joints is disclosed in the Chinese utility model registration publication No. CN211229019 describing the wall comprises a wall body and a wall surface, a groove is dug in the right end of the wall body, a left wood plate is arranged on the left side of the interior of the wall surface, connecting blocks are riveted to the upper side and the lower side of the right end of the left wood plate, right wood plates are riveted to the right ends of the connecting blocks, and a hollow layer is formed between the left wood plate and the right wood plates. The following solution uses rivets as joint elements. Chinese patent application publication No. CN107476445 discloses a cross-laminated timber wall dovetail tenon connection. A cross-laminated timber wall dovetail tenon connecting structure comprises a dovetail tenon wall and a dovetail mortise wall. A dovetail tenon of the dovetail tenon wall is formed in the end face of cross-laminated timber in the longitudinal direction of the wall, a dovetail mortise of the dovetail mortise wall is formed in the plane of the cross-laminated timber in the longitudinal direction of the wall, and the dovetail tenon and the dovetail mortise are in angle fit. When a building of a timber structure is constructed, the dovetail tenon wall and the dovetail mortise wall are aligned in a hoisted mode. Similar tapered dove-tail joints are disclosed in the U.S. Pat. No. 3,090,086 and in French patent application publication No. FR1518263.

European patent publication No. EP1929103 discloses a joint for panels having a first edge and a second edge, the first edge being provided with a distal edge and a downwards protruding heel. The distal edge is further provided with an upper joint edge beneath which a groove is arranged. The second edge is provided with lower cheek having a distal end at which an upwards protruding lower cheek heel is arranged. The second edge is further provided with an upper joining edge beneath which an undercut is arranged. A moveable locking element is arranged in the space created by the undercut. The moveable locking element have a locking tongue, a locking tongue leg and a manoeuvring leg.

Japanese patent application publication No. JP2006183377A discloses a connection structure of wooden building where the wood panels are joint together by the wedge. Similar structure is described in the Japanese patent application publication No. JP2013019219A.

Aim of the invention is to design an easy to manufacture and assemble wall panel structure.

### SUMMARY OF THE INVENTION

The aim is reached by a design of a wall panel joint comprising a first wall panel and a second wall panel interconnected to each other by means of locking features at the edges of said wall panels and by means of wedges, particularly a set of two wedges. Both wall panels are made of CLT. CLT panel is a wood panel product made from gluing together layers of solid-sawn lumber, i.e., lumber cut from a single log. Each layer of boards is oriented generally perpendicular to adjacent layers and glued on the wide faces of each board, usually in a symmetric way so that the outer layers have the same orientation. An odd number of layers or configurations with even numbers may be used. Regular timber is an anisotropic material, meaning that the physical properties change depending on the direction at which the force is applied. By gluing layers of wood at right angles, the panel is able to achieve better structural rigidity in both directions. It is similar to plywood but with distinctively thicker laminations or lamellae. CLT wall panels may comprise three to seven layers, preferably five layers.

The wall panel is elongated, rectangular wall panel. The first wall panel has a front face and a back face, spaced apart from the front face, two side edges, where each side edge extends between the front face and the back face on each respective side of the faces, and a top edge and a bottom edge. The front face and the back face are the widest faces compared to the side edges and the top and the bottom edge. The bottom edge is the edge, on which the wall panel is supported, for example, on the base of the building to be made. The top edge is the edge, on which the roof or ceiling may be supported.

The first wall panel in the middle section and on the back face thereof comprises a T-slot. The T-slot in its cross section represents a letter T. Similar T-slots are used on machining tables or bases in metal machining. The T-slot is formed along entire back face of the first wall panel.

The second wall panel has two wide faces spaced apart from each other, a first side edge and a second side edge, where each side edge extends between the two wide faces on each respective side of the wide faces, and a top edge and a bottom edge. The bottom edge is the edge, on which the wall panel is supported, for example, on the base of the building to be made. The top edge is the edge, on which the roof or ceiling may be supported.

The first side edge of the second wall panel comprises the L-type extension or extension representing letter L in its cross-section. The base or flange part of the L-type extension is arranged at furthest side or distal side of the L-type extension in relation to the first side edge of the second wall.

The T-slot of the first wall panel is formed so that upon assembly of the first wall panel with the second wall panel the L-type extension of the second wall panel is received in the T-slot of the first wall panel and a wedge space is formed. The width of the open section of the T-slot is such that the L-type extension can be inserted into the T-slot by moving the second wall panel sideways to the first wall panel. This feature allows to assemble both wall panels without lifting any of said wall panels. In typical fit a panels should be slide into a slot that copies an extension. In construction works, it would require lifting one of the wall panels, which considerably increases a complexity of assembly. The present invention where the T-slot of the first wall panel is larger than the L-type extension of the second wall panel avoids any dangerous and work consuming lifting operations. Upon assembly of both wall panels, the wedge space is formed, wherein the wedge space is defined by the L-type extension and the T-slot of the first wall panel. The wedge space is also formed by the L-type extension of the second wall panel and the T-slot of the first wall panel. The set of two wedges is inserted into the wedge space with interference fit. Two wedges inserted into the wedge space are so tightly fit with the part of the L-type extension of the second wall panel and the part of the T-slot of the first wall panel that no empty space is left providing secure joint of both panels.

The only empty space is a gap formed between the L-type extension of the second wall panel and the T-slot of the first wall panel, but this does not influence overall security and reliability of the joint. This gap is a result of the feature that a width of a base of the L-type extension of the second wall panel is smaller than a open section width of an open section of the T-slot of the first wall panel so that the L-type extension of the second wall panel is insertable into the T-slot (8) of the first wall panel through the open section of the T-slot of the first wall panel. The open section of the T-slot is on the back face of the first wall panel.

Each wedge is in the form of elongated bar and one side edge of the wedge is inclined so that upon assembly of the first wall panel with the second wall panel both wedges can be inserted into the wedge space, in result of which an interference fit is formed between the both wedges and both wall panels. The wedge has a first end with a first end cross section and a second end with a second end cross section. The first end cross section of the wedge is smaller than the second end cross section of the same wedge, in result of which one side edge of the wedge is inclined in relation to opposed side edge, wherein all other edges are straight. Upon insertion of the wedges into the wedge space both wedges are opposed to each other with its inclined edges. The wedge comprises four side edges and two ends-a first end and a second end. The cross section of the second end of the wedge is in the form of a square and the cross section of the first end of the same wedge is in the form of a rectangle. The longest side of the rectangle of the cross section of the first end of the wedge is equal to the one side of the square of the cross section of the second end of the same wedge. The shortest side of the rectangle of the first end cross section of the first end is one third from the one side of the square of the cross section of the second end of the same wedge.

In result of aforementioned features-T-slot of the first wall panel, L-type extension of the second wall panel that upon assembly form a wedge space, into which two wedges are inserted forming interference fit-a reliable locking of both wall panels is provided being simple to manufacture.

The first wall panel comprises additional features in order to provide a joint for longitudinal build-up of a wall, would it be exterior or interior wall of the building. Each side edge of the first wall panel comprises a protrusion extending thereof. The protrusion extends from the side edge of the first wall panel so that one of the faces of the protrusion is on the same level as the surface of the front face and the back face. Each side edge of the first panel comprises a groove adjacent to the protrusion. The protrusion as well as the groove are formed along entire side edge of the first wall panel. At the end or tip of the protrusion a heel is formed. The heel extends from the protrusion generally orthogonal forming a hook-like feature. In addition the heel comprises a lip extending from the heel and in the direction away from the side edge of the first wall panel. The heel is formed along entire protrusion of the first wall panel and the lip is formed along entire heel of the first wall panel.

Upon assembly of two adjacent first wall panels the heel with the lip on one first wall panel are inserted into the groove of the adjacent first wall panel and both assembled first wall panels form a wedge space defined by the heels and protrusions of both assembled first wall panels. The two wedges are inserted into the wedge space so that the interference fit is formed between the both wedges and both first wall panels securing thereof. In other words two wedges are inserted into the wedge space in such a tightly fit manner with the part of the heels and the part of the protrusions of both assembled wall panels that no empty space is left. Aforementioned features allow to assemble first wall panels without lifting any of said first wall panels. No lifting of one of the first wall panels in necessary, which considerably decreases a complexity of assembly. Hence, dangerous and work consuming lifting operations are avoided.

The second wall panel on the other or the second side edge thereof comprises the same technical features as the side edges of the first wall panel so that the second wall panel with its second edge can be joined with the first wall panel forming a wall. The second side edge of the second wall panel comprises the protrusion extending thereof and the groove adjacent to the protrusion. The protrusion as well as the groove are formed along entire second side edge of the second wall panel. The protrusion extends from the second side edge of the second wall panel so that one of the faces of the protrusion is on the same level as the surface of the wide face. The protrusion as well as the groove are formed along entire second side edge of the second wall panel. At the end or tip of the protrusion a heel is formed. The heel extends from the protrusion generally orthogonal forming a hook-like feature. In addition, the heel comprises a lip extending from the heel and in the direction away from the second side edge of the second wall panel. The heel is formed along entire protrusion of the second wall panel and the lip is formed along entire heel of the second wall panel. Upon assembly of the second wall panel with adjacent first wall panel the heel and the lip of the second wall panel are inserted into the groove of the adjacent first wall panel and both assembled wall panels form a wedge space defined by the heels and the protrusions of both assembled wall panels. Subsequently the two wedges are inserted into the wedge space so that the interference fit is formed between the both wedges and both wall panels. The two wedges are inserted into the wedge space so tightly with the part of the heels and part of the protrusions of both assembled wall panels that no empty space is left. The assembly of the first wall panel and the second wall panel is performed in the same manner as it is performed for assembly of the first wall panels.

The wall panels and wedges are processed to obtain certain moisture content. The moisture content of the first wall panel and the second wall panel is in the range of 10% to 16%, preferably 12%. The moisture content of the wedge (30) is in the range of 5% to 9%, preferably 7%.

### BRIEF DESCRIPTION OF THE DRAWINGS

The drawings illustrate generally, by way of example, but not by way of limitation, various embodiments of the invention.

FIG. 1 is a perspective view of a wall panel joint comprising a first wall panel (1) and a second wall panel (20) as well as a set of two wedges (30) to be inserted in a wedge space (39).

FIG. 2 is a perspective upper view of a wall panel joint wherein a second wall panel (20) with its L-type extension (27) is inserted into a T-slot (8) of a first wall panel (1) and a set of two wedges (30) is ready to be inserted into a wedge space (39).

FIG. 3 is a perspective view of the wall panel joint as seen in FIG. 2 where the set of two wedges (30) is partly inserted into the wedge space (39).

FIG. 4 is a perspective upper view of the wall panel joint wherein a second wall panel (20) with its L-type extension (27) is inserted into a T-slot (8) of a first wall panel (1) and a set of two wedges (30) is completely inserted into a wedge space (39). In addition, three first wall panels (1) are interconnected to each other and the wedges (30) are inserted into their wedge spaces (93).

FIG. 5 is a cross sectional view of a wall panel joint as seen in FIG. 4.

FIG. 6 is a side view of a set of wedges (30).

FIG. 7 is a cross sectional view of a set of wedges (30) as seen in FIG. 6 A-A.

FIG. 8 is a cross sectional view of a first wall panel (1), a second wall panel (20) and a set of wedges (30) before their assembly.

FIG. 9 is a cross sectional view of a wall panel joint comprising a first wall panel (1), a second wall panel (20) and a set of wedges (30).

FIG. 10 is a cross sectional view of a first wall panel (1) that does not comprise a T-slot (8).

FIG. 11 is a cross sectional view of a wall panel joint comprising two assembled first wall panels (1) with a set of two wedges (30) inserted in a wedge space (39) with an interference fit.

FIG. 12 is a perspective upper view of a building assembled from first wall panels (1) and second wall panels (20).

### DETAILED DESCRIPTION OF THE EMBODIMENTS

The preferred embodiments of the invention are now described with reference to the figures to illustrate objectives, advantages, and efficiency of the present invention.

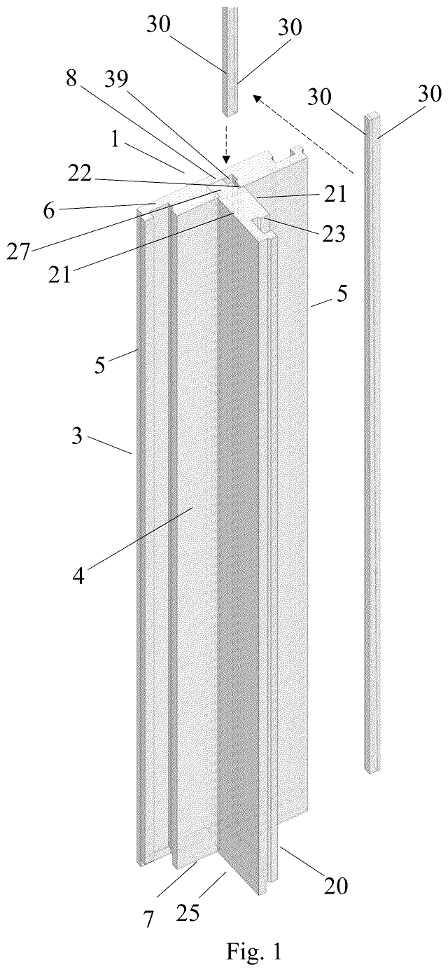

FIG. 1 illustrates a wall panel joint comprising a first wall panel (1) and a second wall panel (20) as well as a set of two wedges (30) to be inserted in a wedge space (39) as well as a principal scheme on how the set of two wedges (30) is inserted into the wedge space (39).

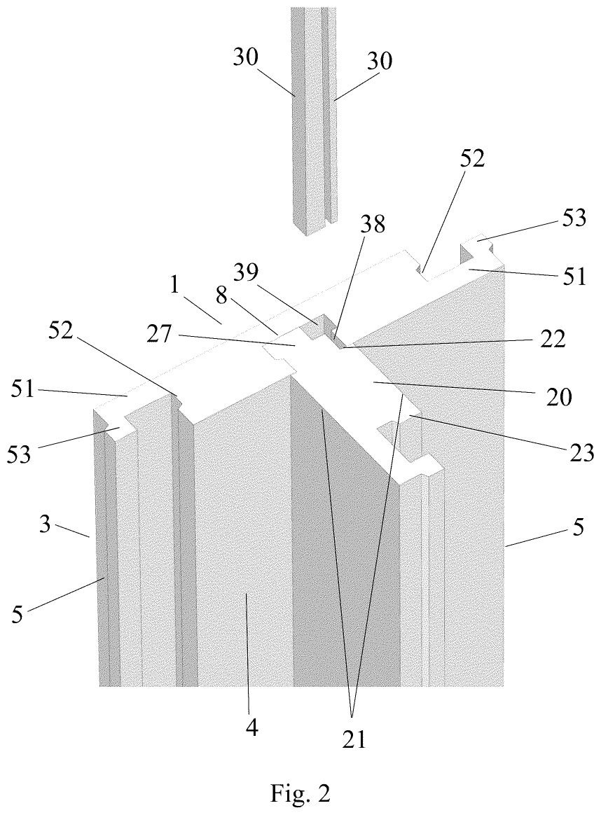

FIG. 2 is a close-up perspective upper view of a wall panel joint wherein a second wall panel (20) with its L-type extension (27) is inserted into a T-slot (8) of a first wall panel (1) and a set of two wedges (30) is ready to be inserted into a wedge space (39). As it can be seen from FIG. 2, the L-type extension (27) can be inserted into the T-slot (8) of the first wall panel (1) sideways or from a side without the need to lift any of the wall panels so to insert a L-type extension (27) of the second wall panel (20) into the T-slot (8) of the first wall panel (1). A gap (38) also is formed, but that gap (38) stays empty even after insertion of the wedges (30). The gap (38) is formed between the L-type extension (27) of the second wall panel (20) and the T-slot (8) of the first wall panel (1).

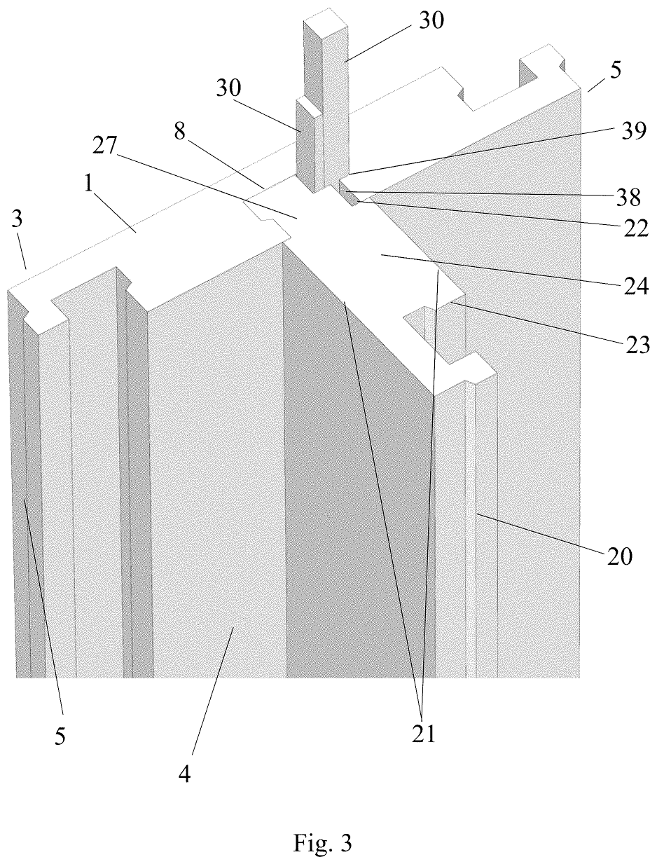

FIG. 3 is a close-up perspective upper view of a wall panel joint as seen on FIG. 3, wherein a second wall panel (20) with its L-type extension (27) is inserted into a T-slot (8) of a first wall panel (1) and a set of two wedges (30) is partly inserted into a wedge space (39) just before providing interference fit.

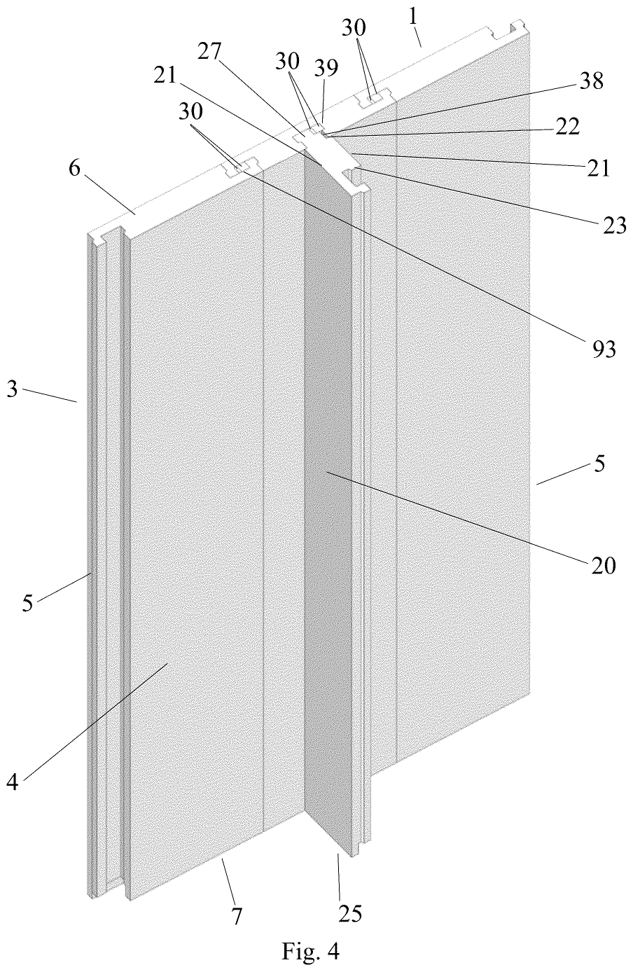

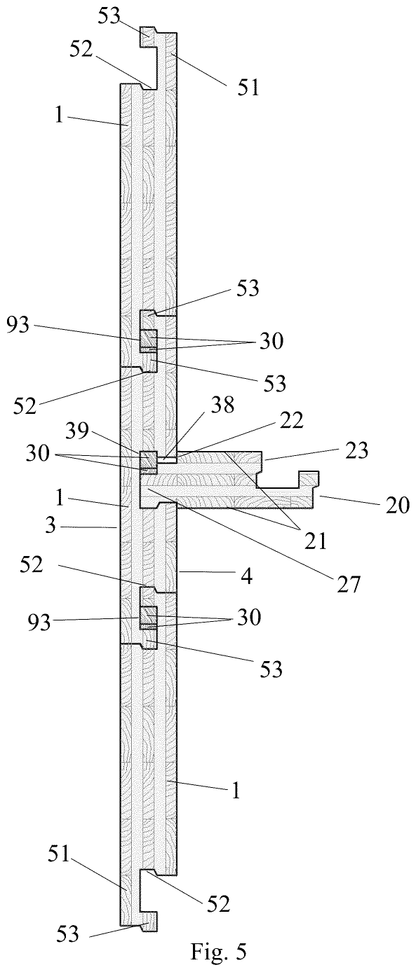

FIG. 4 is a perspective upper view of the wall panel joint wherein a second wall panel (20) with its L-type extension (27) is inserted into a T-slot (8) of a first wall panel (1) and a set of two wedges (30) is completely inserted into a wedge space (39). In addition, three first wall panels (1) are interconnected to each other and the wedges (30) are inserted into their wedge spaces (93). FIG. 5 is a cross sectional view of a wall panel joint as seen in FIG. 4

FIGS. 1 to 5 illustrate the wall panel joint with its joint features. The first wall panel (1) in the middle section and on the back face (4) thereof comprises a T-slot (8). The first side edge (22) of the second wall panel (20) comprises a L-type extension (27). The T-slot (8) of the first wall panel (1) is formed so that upon assembly of the first wall panel (1) with the second wall panel (20), the L-type extension (27) of the second wall panel (20) is received in the T-slot (8) of the first wall panel (1) and a wedge space (39) is formed. The wedge space (39) is defined by the L-type extension (27) of the second wall panel (20) and the T-slot (8) of the first wall panel (1). Upon assembly of both wall panels (1; 20) the set of two wedges (30) are inserted into the wedge space (39) with interference fit forming reliable wall panel joint. FIG. 5 illustrates an assembly of three first wall panels (1) and one second wall panel (20) on a side of one first wall panel (1). In a cross-sectional view of FIG. 5 the CLT structure of the panels (1; 20) is clearly visible. In this embodiment of the invention, each panel (1; 20) has five layers.

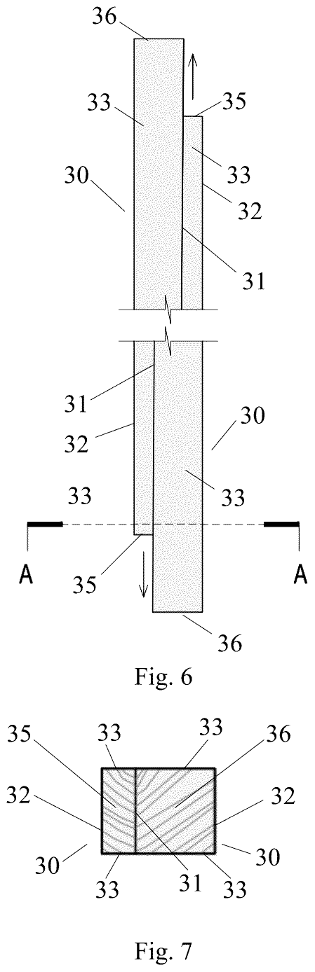

FIGS. 6 and 7 illustrates a set of two wedges (30). Each wedge (30) is in the form of elongated bar and one side edge (31) of the wedge (30) is inclined so that upon assembly of the first wall panel (1) with the second wall panel (20) both wedges (30) are inserted into the wedge space (39) so that the interference fit is formed between the both wedges (30) and both wall panels (1; 20). The wedge (30) has a first end (35) with a first end cross section and a second end (36) with a second end cross section. The first end cross section is smaller than the second end cross section, in result of which one side edge (31) of the wedge (3) is inclined in relation to opposed side edge (32). Moreover, the second end cross section of the second end (36) of the wedge (30) is in the form of a square and the first end cross section of the first end (35) of the same wedge (30) is in the form of a rectangle. The longest side of the rectangle of the first end cross section of the first end (35) of the wedge (30) is equal to the one side of the square of the second end cross section of the second end (36) of the same wedge (30). However, the shortest side of the rectangle of the first end cross section of the first end (35) is one third from the one side of the square of the second end cross section of the second end (36) of the same wedge (30).

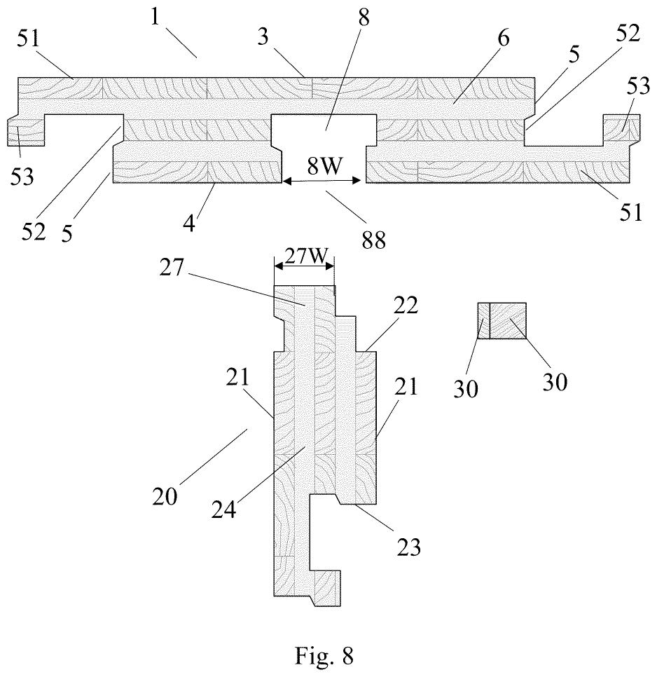

FIG. 8. is a cross sectional view of the first wall panel (1), the second wall panel (20) and the set of wedges (30) before their assembly. The first wall panel (1) has a front face (3) and a back face (4), two side edges (5), wherein each side edge (5) extends between the front face (3) and the back face (4) on each respective side of the faces (3; 4), and a top edge (6) and a bottom edge (7) (not seen in FIG. 8). The second wall panel (20) having a two wide faces (21) spaced apart from each other, a first side edge (22) and a second side edge (23). Each side edge (22; 23) extends between the two wide faces (21) on each respective side of the wide faces (21), and a top edge (24) and a bottom edge (25) (not seen in FIG. 8). The first wall panel (1) in the middle section and on the back face (4) thereof comprises the T-slot (8). The first side edge (22) of the second wall panel (20) comprises the L-type extension (27). The width (27W) of the base of the L-type extension (27) of the second wall panel (20) is smaller than the open section width (8W) of the open section (88) of the T-slot (8) of the first wall panel (1) so that the L-type extension (27) of the second wall panel (20) is insertable from a side into the T-slot (8) of the first wall panel (1) through the open section (88) of the T-slot (8) of the first wall panel (1). The wall panel joint further comprises two wedges (30) that are inserted upon assembly of the first wall panel (1) and the second wall panel (20).

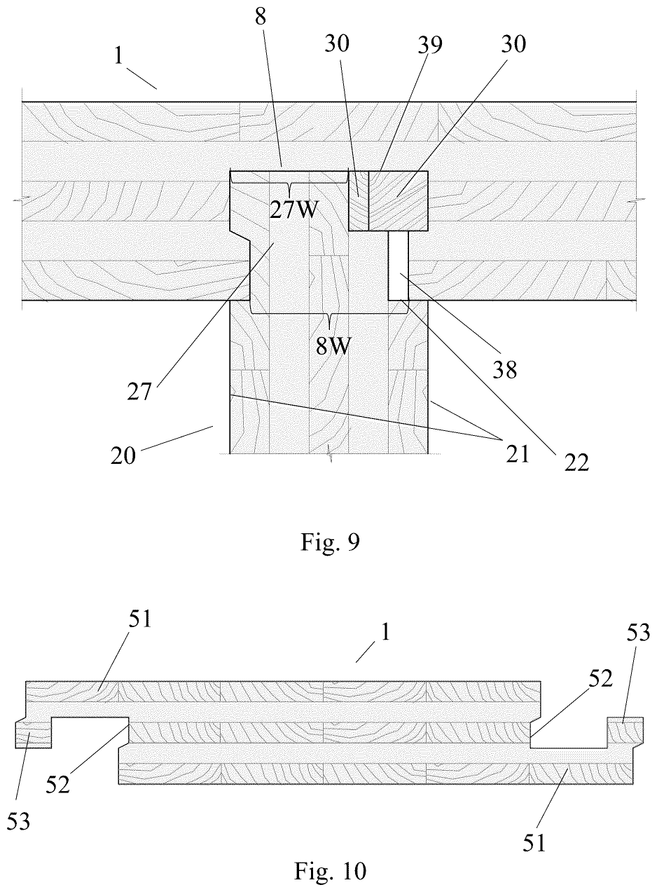

FIG. 9 is a close-up cross sectional view of a wall panel joint where the first wall panel (1), the second wall panel (20) and the set of wedges (30) as seen in FIG. 8 are in assembled state.

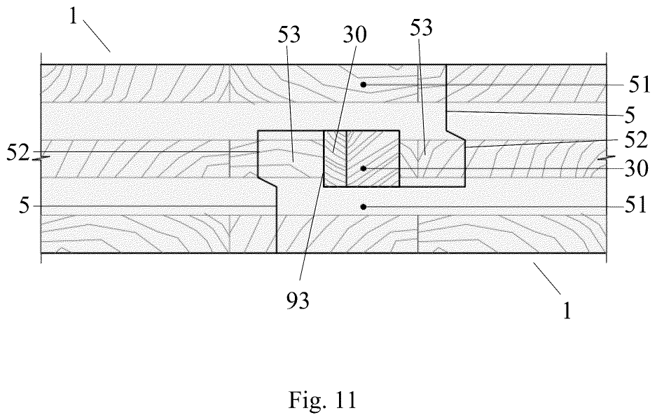

FIG. 10 is a cross sectional view of a first wall panel (1) that does not comprise a T-slot (8). Moreover, each side edge (5) of the first wall panel (1) comprises a protrusion (51) extending thereof and each side edge (5) of the first panel (1) comprises a groove (52) adjacent to the protrusion (51) At the end of the protrusion (51) a heel (53) is formed so that upon assembly of two adjacent first wall panels (1) the heel (53) on one first wall panel (1) is inserted into the groove (52) of the another adjacent first wall panel (1) and both assembled first wall panels (1) form a wedge space (93) defined by the heels (53) and protrusions (51) of both assembled first wall panels (1). The two wedges (30) are inserted into the wedge space (93) so that the interference fit is formed between both wedges (30) and both first wall panels (1) as seen in FIG. 11.

The first wall panel (1) and the second wall panel (20) are made of cross laminated timber (CLT) panels having five layers as seen in FIGS. 5, 8 to 11.

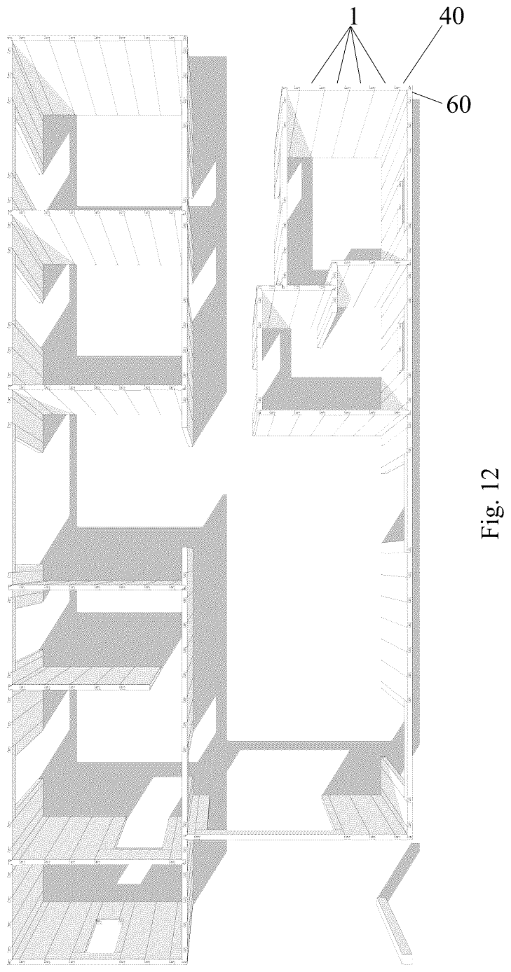

In result of joining said wall panels (1; 20) in aforementioned manner a building can be made as illustrated in FIG. 12.

While the invention may be susceptible to various modifications and alternative forms, specific embodiments of which have been shown by way of example in the figures and have been described in detail herein, it should be understood that the invention is not intended to be limited to the particular forms disclosed. Rather, the invention includes all modifications, equivalents, and alternatives falling within the scope of the invention as defined by the following claims.

### LIST OF REFERENCES

1—a first wall panel;
3—a front face of a first wall panel;
4—a back face of a first wall panel;
5—side edge of a first wall panel;
6—a top edge of a first wall panel;
7—a bottom edge of a first wall panel;
8—a T-slot of a first wall panel;
20—a second wall panel;
21—a wide face of a second wall panel;
22—a first side edge of a second wall panel;
23—a second side edge of a second wall panel
24—a top edge of a second wall panel
25—a bottom side edge of a second wall panel
26—a groove of the second wall;
27—a L-type extension;
27W—a width of a base of a L-type extension;
30—a wedge;
31—an inclined side edge of a wedge;
32—a side edge opposed to an inclined side edge of a wedge;
33—a side edge of a wedge;
35—a first end of a wedge;
36—a second end of the wedge;
38—a gap;
39—a wedge space between joined first wall panel and a second wall panel;
51—a protrusion;
52—a groove;
53—a heel;
54—a lip;
88—an open section of a T-slot; and
93—a wedge space between the two joined first wall panels.

1. A wall panel joint comprising:
a first wall panel having a front face and a back face, spaced apart from the front face, two side edges, where each side edge extends between the front face and the back face on each respective side of the faces, and a top edge and a bottom edge;
a second wall panel having two wide faces spaced apart from each other, a first side edge and a second side edge where each side edge extends between the two wide faces on each respective side of the wide faces, and a top edge and a bottom edge;
wherein the first wall panel in the middle section and on the back face thereof comprises a T-slot,
wherein the first side edge of the second wall panel comprises an L-type extension,
wherein the T-slot of the first wall panel is formed so that upon assembly of the first wall panel with the second wall panel, the L-type extension of the second wall panel is received in the T-slot of the first wall panel and a wedge space is formed,
wherein the wedge space is defined by the L-type extension of the second wall panel and the T-slot of the first wall panel,
wherein the wall panel joint further comprises two wedges, wherein each wedge is in the form of elongated bar and one side edge of the wedge is inclined so that upon assembly of the first wall panel with the second wall panel both wedges are inserted into the wedge space so that the interference fit is formed between both wedges and both wall panels; and
wherein the first wall panel and the second wall panel are made of cross laminated timber (CLT) panels.

2. The wall panel joint according to claim 1, characterized in that, in addition to the wedge space, a gap is formed between the L-type extension of the second wall panel and the T-slot of the first wall panel.

3. The wall panel joint according to claim 1, characterized in that a width (27W) of a base of the L-type extension of the second wall panel is smaller than an open section width (8W) of an open section of the T-slot of the first wall panel so that the L-type extension of the second wall panel is insertable into the T-slot of the first wall panel through the open section of the T-slot of the first wall panel.

4. The wall panel joint according to claim 1, characterized in that each side edge of the first wall panel comprises a protrusion extending thereof and each side edge of the first panel comprises a groove adjacent to the protrusion, wherein at the end of the protrusion a heel is formed so that upon assembly of two adjacent first wall panels the heel on one first wall panel is inserted into the groove of the another adjacent first wall panel and both assembled first wall panels form a wedge space defined by the heels and protrusions of both assembled first wall panels, and wherein the two wedges are inserted into the wedge space so that the interference fit is formed between the both wedges and both first wall panels.

5. The wall panel joint according to claim 1, characterized in that the wedge having a first end with a first end cross section and a second end with a second end cross section, wherein the first end cross section is smaller than the second end cross section, in result of which one side edge of the wedge is inclined in relation to opposed side edge.

6. The wall panel joint according to claim 1, characterized in that the second end cross section of the second end of the wedge is in the form of a square and the first end cross section of the first end of the same wedge is in the form of a rectangle, wherein the longest side of the rectangle of the first end cross section of the first end of the wedge is equal to the one side of the square of the second end cross section of the second end of the same wedge, and wherein the shortest side of the rectangle of the first end cross section of the first end is one third from the one side of the square of the second end cross section of the second end of the same wedge.

7. The wall panel joint according to claim 1, characterized in that the moisture content of the first wall panel and the second wall panel is in the range of 10% to 16%, preferably 12%, and the moisture content of the wedge is in the range of 5% to 9%, preferably 7%.

8. The wall panel joint according to claim 1, characterized in that the second side edge of the second wall panel comprises the protrusion extending thereof and the groove adjacent to the protrusion wherein at the end of the protrusion the heel is formed so that upon assembly of the second wall panel with adjacent first wall panel the heel of the second wall panel is inserted into the groove of the adjacent first wall panel and both assembled wall panels, form a wedge space defined by the heels and the protrusions of both assembled wall panels and wherein the two wedges are inserted into the wedge space so that the interference fit is formed between the both wedges and both wall panels.

9. The wall panel joint according to claim 1, characterized in that two wedges inserted into the wedge space are so tightly fit with the part of the L-type extension of the second wall panel and the part of the T-slot of the first wall panel that no empty space is left in the wedge space.

10. The wall panel joint according to claim 1, characterized in that two wedges inserted into the wedge space are so tightly fit with the part of the heels and part of the protrusions of both assembled wall panels that no empty space is left in the wedge space.
